(19) United States
(12) Patent Application Publication
(10) Pub. No.: US 2017/0274686 A1
(43) Pub. Date: Sep. 28, 2017

(54) PRINTER

(71) Applicant: Funai Electric Co., Ltd., Osaka (JP)

(72) Inventor: Toshiro Tani, Osaka (JP)

(73) Assignee: Funai Electric Co., Ltd., Osaka (JP)

(21) Appl. No.: 15/471,854

(22) Filed: Mar. 28, 2017

(30) Foreign Application Priority Data
Mar. 28, 2016 (JP) 2016-063433

(51) Int. Cl. B41J 29/02

(52) U.S. Cl. CPC B41J 29/02

(57) ABSTRACT

A printer includes a printing head and a plurality of recessed portions disposed to oppose the printing head. A depth of each of the recessed portions is larger than a shortest distance of an opening portion of each recessed portion in a planar view. The shortest distance is a width of the opening portion in a view from a medium feeding direction or a width of the opening portion in a view from a moving direction of the printing head.

### BACKGROUND

Technical Field

The present invention generally relates to a printer.

Related Art

Conventional printers include an ink receiving portion (for example, see patent literature 1).

Patent literature 1 discloses an ink jet printer (printer) including a recording head and a platen disposed in a position opposing the recording head. In this ink jet printer, a recessed portion (ink receiving portion) with an ink absorbing material disposed is provided on the platen, the ink absorbing material being for absorbing ink discharged from a region separated from end portions of a sheet. In this ink jet printer, when performing printing without space on the end portions of the sheet, or so-called no margin printing, the ink discharged from the region separated from end portions of the paper is absorbed by the ink absorbing material disposed on the recessed portion.
Patent Literature 1: Japanese Patent No. 4258626

### SUMMARY

However, in the ink jet printer described in patent literature 1, because ink absorbing material is provided to absorb ink during no margin printing, the cost increases by the amount of ink absorbing material. Because of this, one option for reducing cost is to not provide ink absorbing material. However, when ink absorbing material is not provided, ink accumulates in the recessed portion where the ink absorbing material would be provided. In this case, if the ink jet printer described in patent literature 1 is tilted, ink that has accumulated in the recessed portion may overflow from the recessed portion to the outside.

One or more embodiments of the present invention provides a printer that can suppress ink overflowing to the outside even when an ink absorbing material is not provided.

A printer according to one or more embodiments of the present invention may comprise a printing head that discharges ink on a medium, and a recessed portion group made up of a plurality of recessed portions disposed in a position opposing the printing head. The depth of each recessed portion of the recessed portion group may be larger than the shortest width of an opening portion of each recessed portion in a planar view.

In a printer according to one or more embodiments of the present invention, the depth of each recessed portion of the recessed portion group is made to be larger than the shortest width of the opening portion of each recessed portion in a planar view. By this, ink is held in each recessed portion of the recessed portion group by atmospheric pressure when the printer is tilted. As a result, it is possible to suppress ink from overflowing to the outside even when an ink absorbing material is not provided. Furthermore, more ink can be accumulated in each recessed portion because the capacity of each recessed portion can be made larger. As a result, ink accumulated in each recessed portion exceeding an amount that can be stored and overflowing can be suppressed.

In a printer according to the one or more embodiments of the present invention, the depth of each recessed portion is larger than two times the shortest width of the opening portion in a planar view. If configured in this manner, even more ink can be accumulated in each recessed portion because the capacity of each recessed portion can be made even larger. As a result, ink accumulated in each recessed portion exceeding an amount that can be stored and overflowing can be further suppressed.

In a printer according to the one or more embodiments of the present invention, each recessed portion has a shape tapering from the opening portion to a bottom portion of each recessed portion. If configured in this manner, ink can easily be accumulated in each recessed portion because it is easier for ink that has entered from the opening portion to slide and fall toward the bottom portion. Furthermore, when forming the recessed portion group by resin using resin molding, resistance when taking the recessed portion group out of the resin mold can be made smaller by each recessed portion having a shape tapering from the opening portion to the bottom portion. By this, it can be easier to take the recessed portion group out of the resin mold. Therefore, the disposing position of each recessed portion can be closer because the recessed portion group can be easily taken out from the resin mold even if each recessed portion is relatively close. As a result, because the surface area of portions where each recessed portion is not formed can be reduced, it becomes easier for ink discharged from the printing head to be accumulated in each recessed portion.

For example, the opening portion has a substantially circular shape in a planar view, and if each recessed portion is formed so that the diameter of the circle gradually decreases from the opening portion to the bottom portion. If configured in this manner, each recessed portion can be formed having a tapering shape by a simple configuration.

In a configuration where the opening portion of each recessed portion has a substantially circular shape in a planar view, the diameter of the opening portion may be 1.0 mm or more, and 2.5 mm or less. If configured in this manner, by making the diameter of the opening portion having a substantially circular shape be 1.0 mm or more, each recessed portion can be easier to form compared to when the diameter of the opening portion having a substantially circular shape is smaller than 1.0 mm. This effect is particularly effective when forming the ink receiving portion by resin using a resin mold. Furthermore, by making the diameter of the opening portion having a substantially circular shape 2.5 mm or less, ink can surely be held in each recessed portion by atmospheric pressure.

In a configuration where each recessed portion has a tapering shape, the opening portion has a substantially rectangular shape in a planar view, and if each recessed portion is formed so that the length of the four sides of the rectangular shape gradually decrease from the opening portion toward the bottom portion. If configured in this manner, it is easier for ink that has entered from the opening portion to slide and fall toward the bottom portion because each recessed portion has a tapering shape so that the length of all sides of the rectangular shape (four sides) gradually decrease.

In a printer according to the one or more embodiments of the present invention, each recessed portion is arranged along a predetermined direction in a planar view. If configured in this manner, because the surface area of portions where each recessed portion is not formed can be reduced, it becomes easier for ink discharged from the printing head to be accumulated in each recessed portion, different than when each recessed portion is disposed irregularly.

In this case, the predetermined direction includes the movement direction of the printing head. If configured in this manner, it becomes easier for ink discharged from the printing head to be accumulated in each recessed portion, because each recessed portion is arranged along the movement direction of the printing head.

In a configuration where each recessed portion is arranged along a predetermined direction, the predetermined direction includes a direction orthogonal to the movement direction of the printing head. If configured in this manner, ink can be easily accumulated in each recessed portion even when ink is discharged from the printing head expanding in the direction orthogonal to the movement direction of the printing head.

In a configuration where each recessed portion is arranged along a predetermined direction, the recessed portion group is disposed on a disposing region having a substantially rectangular shape in a planar view, and the opening portion is formed extending from the vicinity of an end portion of one side on the disposing region to the vicinity of an end portion opposite the end portion on the one side. If configured in this manner, the number of recessed portions disposed on the disposing region can be reduced because the capacity of one recessed portion can be made larger. As a result, each recessed portion can be easier to form.

In a configuration where each recessed portion is arranged along a predetermined direction, the distance between adjacent recessed portions is less than the shortest width of the opening portion in a planar view. If configured in this manner, the surface area of portions where each recessed portion is not formed can be reduced because the disposing position of each recessed portion can be closer. As a result, it becomes easier for ink discharged from the printing head to be accumulated in each recessed portion.

In a printer according to the one or more embodiments of the present invention, the bottom portion of each recessed portion is formed in a flat surface shape. If configured in this manner, it becomes easier to form each recessed portion because the bottom portion of each recessed portion can be made into a simple shape. This effect is particularly effective when forming the recessed portion group by resin using a resin mold.

A printer according to the one or more embodiments of the present invention further comprises a platen portion for supporting the medium. The recessed portion group is disposed lower than a supporting surface of the medium on the platen portion. As a result, ink accumulated in each recessed portion can be suppressed from adhering to the medium.

According to the one or more embodiments of the present invention, the recessed portion group may be integrally formed having the platen portion. As a result, the recessed portion group can be provided on the printer while suppressing the number of components from increasing.

A printer according to the one or more embodiments of the present invention further comprises a housing, and the platen portion and the recessed portion group are integrally formed having the housing. As a result, the recessed portion group can be provided on the printer while suppressing the number of components from increasing.

In a printer according to the one or more embodiments of the present invention, each recessed portion has a beveled opening portion. As a result, it can be made so that it is easier for ink to enter into each recessed portion because the opening portion is larger, and ink discharged from the printing head can be surely accumulated in each recessed portion because the surface area of portions where each recessed portion is not formed can be reduced.

In a printer according to the one or more embodiments of the present invention, the recessed portion group may be configured by two or more types of recessed portions having different shortest widths of the opening portion. As a result, each recessed portion can easily be densely disposed. As a result, because the surface area of portions where each recessed portion is not formed can be reduced, ink discharged from the printing head can be surely accumulated in each recessed portion.

In a configuration further providing a platen portion, the width of the recessed portion group in the movement direction of the printing head is larger than the width of the supporting surfaces in the movement direction of the printing head. If configured in this manner, discharged ink sticking out of the medium can be surely accumulated in each recessed portion.

According to one or more embodiments of the present invention, a printer may comprise a printing head and a plurality of recessed portions disposed to oppose the printing head. A depth of each of the recessed portions may be larger than a shortest distance of an opening portion of each recessed portion in a planar view.

One or more embodiments of the present invention provides a printer that can suppress ink from overflowing to the outside even when an ink absorbing material is not provided.

### BRIEF DESCRIPTION OF DRAWINGS

FIG. 1 is a schematic drawing illustrating a printer according to one or more embodiments of the present invention.

FIG. 2 is a planar view illustrating an ink receiving portion of the printer according to a first embodiment of the present invention.

FIG. 3 is a cross-sectional view illustrating the ink receiving portion of the printer according to the first embodiment of the present invention.

FIG. 4 is a perspective view illustrating a recessed portion for accumulating ink of the ink receiving portion of the printer according to the first embodiment of the present invention.

FIGS. 5A-5D are diagrams showing the recognition results of the holding force of ink by recessed portions for accumulating ink having different diameters.

FIG. 6 is a planar view illustrating an ink receiving portion of the printer according to a second embodiment of the present invention.

FIG. 7 is a cross-sectional view illustrating an ink receiving portion of the printer according to the second embodiment of the present invention.

FIG. 8 is a perspective view illustrating a recessed portion for accumulating ink of the ink receiving portion of the printer according to the second embodiment of the present invention.

FIG. 9 is a planar view illustrating the ink receiving portion of the printer according to a third embodiment of the present invention.

FIG. 10 is a cross-sectional view illustrating the ink receiving portion of the printer according to the third embodiment of the present invention.

FIG. 11 is a perspective view illustrating a recessed portion for accumulating ink of the ink receiving portion of the printer according to the third embodiment of the present invention.

FIG. 12 is a planar view illustrating an ink receiving portion of the printer according to a first modified example of the first embodiment of the present invention.

FIG. 13 is a cross-sectional view illustrating the ink receiving portion of the printer according to the first modified example of the first embodiment of the present invention.

FIG. 14 is a planar view illustrating an ink receiving portion of the printer according to a second modified example of the first embodiment of the present invention.

FIG. 15 is a cross-sectional view illustrating the ink receiving portion of the printer according to the second modified example of the first embodiment of the present invention.

FIG. 16 is a planar view illustrating an ink receiving portion of the printer according to a first modified example of the second embodiment of the present invention.

FIG. 17 is a cross-sectional view illustrating an ink receiving portion of the printer according to the first modified example of the second embodiment of the present invention.

FIG. 18 is a planar view illustrating an ink receiving portion of the printer according to a second modified example of the second embodiment of the present invention.

FIG. 19 is a cross-sectional view illustrating an ink receiving portion of the printer according to the second modified example of the second embodiment of the present invention.

FIG. 20 is a planar view illustrating an ink receiving portion of the printer according to a third modified example of the first embodiment of the present invention.

FIG. 21 is a planar view illustrating an ink receiving portion of the printer according to a fourth modified example of the first embodiment of the present invention.

### DETAILED DESCRIPTION

Embodiments of the present invention will be described in detail below with reference to the drawings. In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

(Configuration of Printing Device)

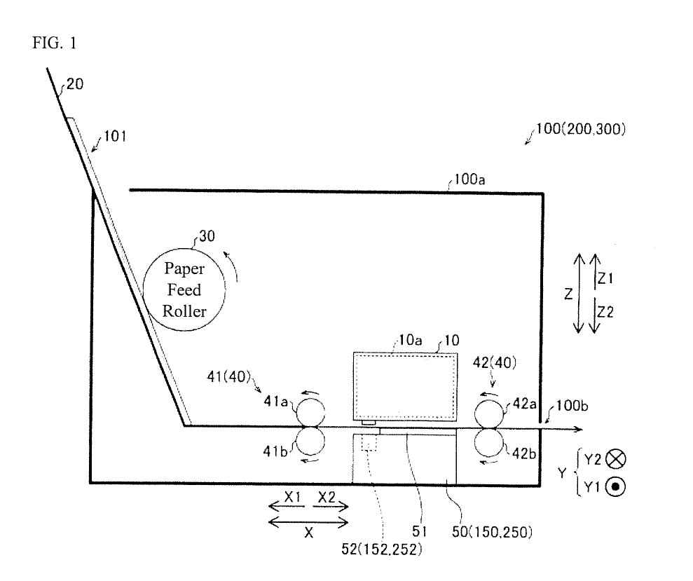

First, a configuration of a printer 100 according to a first embodiment of the present invention will be described referring to FIG. 1.

The printer 100 according to the first embodiment of the present invention is an ink jet type printer that prints an image on a recording medium 101 by discharging ink, as illustrated in FIG. 1. The recording medium 101 is, for example, a sheet. The recording medium 101 is one example of a “medium” in one or more embodiments of the present invention.

The printer 100 includes a printing head 10. The printing head 10 is configured to discharge ink on the recording medium 101. Furthermore, the printing head 10 is configured for an ink cartridge 10a filled with ink to be removably installed. Furthermore, the printing head 10 is configured to move along the Y-direction by a driving mechanism not illustrated in the drawings.

In the printer 100, the printing head 10 is configured to print an image on the recording medium 101 by discharging ink filled in the ink cartridge 10a while moving in the movement direction (Y-direction (moving direction of the printing head 10)).

The movement direction of the printing head 10 is made to be the Y-direction, a sheet feeding direction (medium feeding direction) orthogonal to the Y-direction on a horizontal plane is made to be the X-direction, and a direction orthogonal to the X-direction and the Y-direction is made to the Z-direction (vertical direction).

The printer 100 includes a paper feed tray 20. The paper feed tray 20 is configured to be able to be disposed on the recording medium 101 before printing, to feed the recording medium 101 in a housing 100a of the printer 100.

The printer 100 includes a paper feed roller 30. The paper feed roller 30 is configured to move the recording medium 101 disposed on the paper feed tray 20 toward the printing head 10 by rotating a driving mechanism not illustrated in the drawings.

The printer 100 includes a feeding roller 40. The feeding roller 40 is configured to transport the recording medium 101 along a transport route in the housing 100a of the printer 100. The feeding roller 40 includes an upstream side feeding roller 41 disposed more on the upstream side (X1 side) than the printing head 10, and a downstream side feeding roller 42 disposed more on the downstream side (X2 side) than the printing head 10.

The upstream side feeding roller 41 has a pair of feeding rollers 41a and 41b. The pair of feeding rollers 41a and 41b are disposed on a position both opposing the vertical direction (Z-direction). The pair of feeding rollers 41a and 41b are configured to sandwich the recording medium 101 between the pair of feeding rollers 41a and 41b, and transport it toward the printing head 10 on the downstream side by rotating by a driving mechanism not illustrated in the drawings.

The downstream feeding roller 42 has a pair of feeding rollers 42a and 42b. The pair of feeding rollers 42a and 42b are disposed on a position both opposing the vertical direction. The pair of feeding rollers 42a and 42b are configured to sandwich the recording medium 101 between the pair of feeding rollers 42a and 42b, and transport it toward a paper ejection port 100b on the downstream side by rotating by a driving mechanism not illustrated in the drawings.

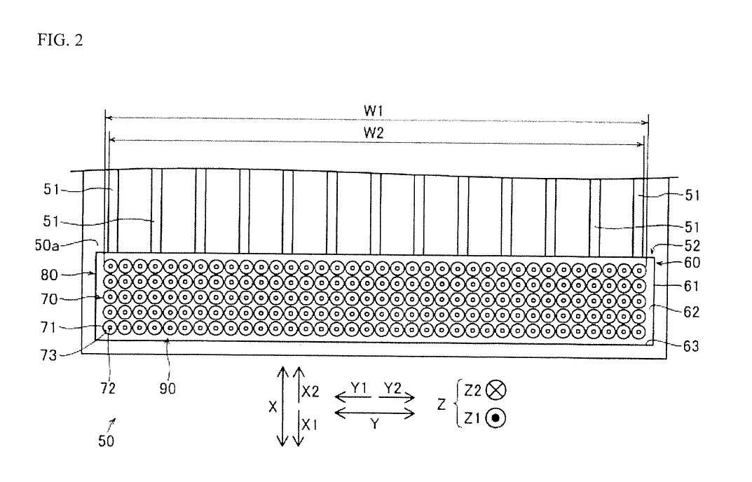

The printer 100 includes a platen portion 50. The platen portion 50 is disposed on a position opposing the printing head 10 and the vertical direction (Z-direction) in the lower part of the printing head 10. The platen portion 50 is configured to support from below the recording medium 101 transported by the feeding roller 40. As illustrated in FIG. 1 and FIG. 2, the platen portion 50 includes a plurality of ribs 51 for supporting the recording medium 101 from below (Z2 direction). The ribs 51 are formed to protrude upward (Z1 direction) from an upper surface 50a of the platen portion 50.

As illustrated in FIG. 1 to FIG. 3, an ink receiving portion 52 is integrally provided on the platen portion 50. The ink receiving portion 52 is disposed on a position opposing the printing head 10, and is configured to receive discharged ink sticking out of the recording medium 101 from the printing head 10. In other words, the ink receiving portion 52 receives discharged ink sticking out of an outline of the recording medium 101 from the printing head 10 during a printing operation for printing an image up until the end portions of the recording medium 101 (during a so-called no margin printing) by sticking out of the outline of the recording medium 101 and discharging ink. By this, discharged ink sticking out of the outline of the recording medium 101 from the printing head 10 is prevented from contaminating the inside of the housing 100a of the printer 100.

The ink receiving portion 52 includes recessed portion 60 that recesses downward from the upper surface 50a of the platen portion 50. The recessed portion 60 has a substantially rectangular shape from a planar view (viewed from the vertical direction) so that the movement direction of the printing head 10 (Y-direction) is the long direction. Specifically, the recessed portion 60 has an opening portion 61 and a bottom portion 62 having a substantially rectangular shape from a planar view, and a wall portion 63 that connects the opening portion 61 and the bottom portion 62. The wall portion 63 is formed from the opening portion 61 to the bottom portion 62 to extend along the vertical direction (Z-direction).

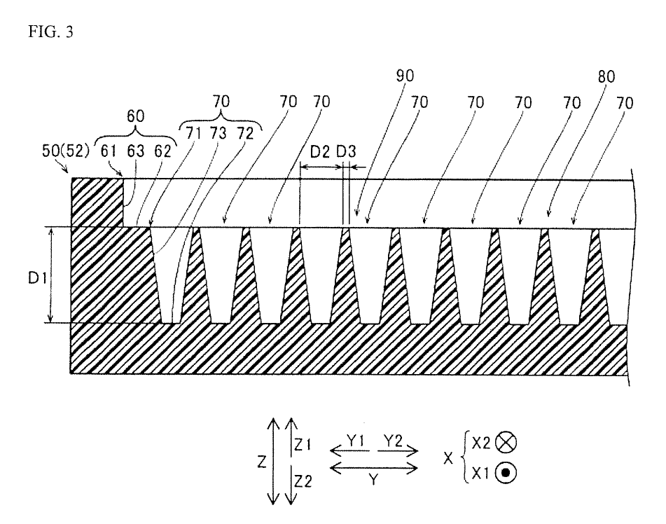

Here, as illustrated in FIG. 2 and FIG. 3, in the first embodiment of the present invention, a recessed portion group 90 for accumulating ink is provided on the bottom portion 62 of the recessed portion 60 of the ink receiving portion 52. The recessed portion group 90 for accumulating ink is configured by a plurality of recessed portions 70 for accumulating ink. The recessed portion group 90 for accumulating ink is one example of “recessed portion group” in one or more embodiments of the present invention. Furthermore, each recessed portion 70 for accumulating ink is one example of “each recessed portion” in one or more embodiments of the present invention. The recessed portions 70 for accumulating ink of the recessed portion group 90 for accumulating ink have a size where it is possible to hold ink by atmospheric pressure (and surface tension). The recessed portion group 90 for accumulating ink is provided further downward (Z2 direction) than the upper surface 50a of the platen portion 50 and a supporting surface (upper surface of the ribs 51) of the recording medium 101 on the platen portion 50. Furthermore, the recessed portions 70 for accumulating ink are formed in a size to hold in the recessed portions 70 for accumulating ink by atmospheric pressure, without spilling ink that has accumulated in the recessed portions 70 for accumulating ink to the outside even when the printer 100 is tilted.

As illustrated in FIG. 2 to FIG. 4, the recessed portions 70 for accumulating ink have an opening portion 71 and a bottom portion 72 having a substantially rectangular shape from a planar view, and a wall portion 73 that connects the opening portion 71 and the bottom portion 72. In the printer 100, discharged ink sticking out of the recording medium 101 from the printing head 10 enters the recessed portions 70 for accumulating ink from the opening portion 71, and accumulates in a space partitioned by the bottom portion 72 and the wall portion 73.

As illustrated in FIG. 3, in the first embodiment of the present invention, a depth (length from the opening portion 71 to the bottom portion 72) D1 of the recessed portions 70 for accumulating ink is larger than a diameter D2 of the opening portion 71 having a substantially circular shape. The diameter D2 is a width of the opening portion 71 in a view from a medium feeding direction (X-direction). For example, the depth D1 of the recessed portions 70 for accumulating ink is two times larger than the diameter D2 of the opening portion 71 having a substantially circular shape. By this, it is possible to increase the capacity of the recessed portions 70 for accumulating ink while keeping the opening area of the recessed portions 70 for accumulating ink small. The diameter D2 of the opening portion 71 having a substantially circular shape is one example of “shortest width (shortest distance) of an opening portion of a recessed portion for accumulating ink in a planar view” in one or more embodiments of the present invention.

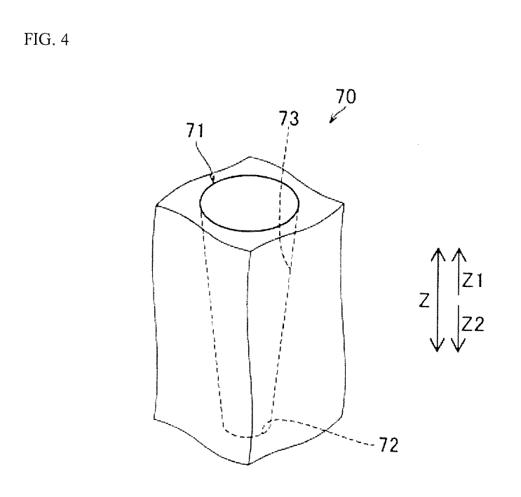

Furthermore, as illustrated in FIG. 3 and FIG. 4, in the first embodiment of the present invention, the wall portion 73 of the recessed portions 70 for accumulating ink have a shape tapering from the opening portion 71 to the bottom portion 72. Specifically, the wall portion 73 of the recessed portions 70 for accumulating ink is formed so that the diameter of the circle gradually decreases (gradually dwindles away) from the opening portion 71 having a substantially circular shape to toward the bottom portion 72 having a substantially circular shape.

Furthermore, the bottom portion 72 of the recessed portions 70 for accumulating ink is formed in a flat surface shape along the horizontal direction. In other words, in the recessed portions 70 for accumulating ink, a substantially cone-shaped space is formed by the opening portion 71, the bottom portion 72, and the wall portion 73. In accumulates in this substantially cone-shaped space. Furthermore, a vertical cross-section (cross-section in the ZY plane) of the recessed portions 70 for accumulating ink has a trapezoidal shape.

Furthermore, the diameter D2 of the opening portion 71 having a substantially circular shape is approximately 1.0 mm or more, and approximately 2.5 mm or less. For example, the diameter D2 of the opening portion 71 having a substantially circular shape is approximately 1.5 mm or more, and approximately 2.5 mm or less. For example, the diameter D2 of the opening portion 71 having a substantially circular shape is approximately 1.5 mm or more, and approximately 2.0 mm or less. For example, the diameter D2 of the opening portion 71 having a substantially circular shape may be small, in terms of holding ink in the recessed portions 70 for accumulating ink by atmospheric pressure. On the other hand, the diameter D2 may be large in terms of simplicity in molding the recessed portions 70 for accumulating ink by a resin mold.

As illustrated in FIG. 2, a disposing region 80 on the ink receiving portion 52 includes the recessed portion group 90 for accumulating ink (plurality of recessed portions 70 for accumulating ink). The disposing region 80 is a region where the recessed portion group 90 for accumulating ink is disposed on the ink receiving portion 52, and in the first embodiment of the present invention, is a region partitioned by the bottom portion 62 of the recessed portion 60 on the ink receiving portion 52. In other words, in the first embodiment of the present invention, the disposing region 80 is a region having a substantially rectangular shape in a planar view.

Furthermore, in the first embodiment of the present invention, the plurality of recessed portions 70 for accumulating ink are arranged with substantially equal spacing therebetween along the movement direction of the printing head 10 (Y-direction) in a planar view on the disposing region 80 on the ink receiving portion 52. Moreover, the plurality of recessed portions 70 for accumulating ink are arranged with substantially equal spacing therebetween along a direction orthogonal to the movement direction of the printing head 10 (X-direction) in a planar view on the disposing region 80. In other words, the plurality of recessed portions 70 for accumulating ink are arranged in a matrix to have a plurality of rows and a plurality of columns on the disposing region 80. Furthermore, the recessed portion group 90 for accumulating ink (plurality of recessed portions 70 for accumulating ink) is provided along substantially the entire region of the disposing region 80. The X-direction and Y-direction are one example of “predetermined direction” in one or more embodiments of the present invention.

Moreover, as illustrated in FIG. 3, a distance D3 between adjacent recessed portions 70 for accumulating ink is smaller than the diameter D2 of the opening portion 71 having a substantially circular shape. In FIG. 2, the distance D3 between recessed portions 70 for accumulating ink adjacent in the Y-direction was illustrated, and the distance between recessed portions 70 for accumulating ink adjacent in the X-direction was also smaller than the diameter D2 of the opening portion 71 having a substantially circular shape. In other words, adjacent recessed portions 70 for accumulating ink are arranged to be sufficiently close to each other on the disposing region 80 (so that a flat portion does not occur between adjacent recessed portions 70 for accumulating ink as much as possible).

Furthermore, as illustrated in FIG. 2, in the first embodiment of the present invention, a width W1 of the entire recessed portion group 90 for accumulating ink in the movement direction of the printing head 10 (Y-direction) is larger than a width W2 of the entire plurality of supporting surfaces (upper surface of the ribs 51) of the platen portion 50 in the movement direction of the printing head 10. In other words, the recessed portion group 90 for accumulating ink is formed more to the outer side than the plurality of supporting surfaces of the platen portion 50 in the movement direction of the printing head 10.

As illustrated in FIG. 1, the housing 100a of the printer 100 is configured to accommodate the printing head 10, the paper feed roller 30, the feeding roller 40, the platen portion 50, and the like. Furthermore, the housing 100a is configured by resin such as polystyrene. Moreover, in the first embodiment of the present invention, the platen portion 50 with the ink receiving portion 52 provided thereon is integrally provided with the housing 100a. In other words, in the first embodiment of the present invention, the housing 100a, the platen portion 50, and the ink receiving portion 52 (recessed portion group 90 for accumulating ink) are integrally molded by resin such as polystyrene using a resin mold.

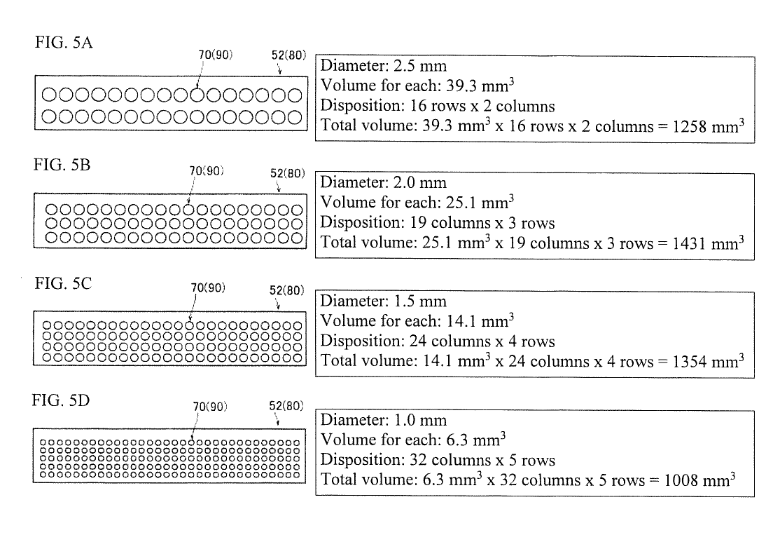

Next, the recognition results of ink holding force by the recessed portions 70 for accumulating ink of the recessed portion group 90 for accumulating ink will be described referring to FIGS. 5A to 5D.

In FIG. 5A, the ink receiving portion 52 is illustrated with the recessed portions 70 for accumulating ink having a diameter of 2.5 mm, a volume of 39.3 mm3, and being arranged in 16 rows and 2 columns in the disposing region 80. In this case, the total volume of the plurality of recessed portions 70 for accumulating ink is 1258 mm3.

In FIG. 5B, the ink receiving portion 52 is illustrated with the recessed portions 70 for accumulating ink having a diameter of 2.0 mm, a volume of 25.1 mm3, and being arranged in 19 rows and 3 columns in the disposing region 80. In this case, the total volume of the plurality of recessed portions 70 for accumulating ink is 1431 mm3.

In FIG. 5C, the ink receiving portion 52 is illustrated with the recessed portions 70 for accumulating ink having a diameter of 1.5 mm, a volume of 14.1 mm3, and being arranged in 24 rows and 4 columns in the disposing region 80. In this case, the total volume of the plurality of recessed portions 70 for accumulating ink is 1354 mm3.

In FIG. 5D, the ink receiving portion 52 is illustrated with the recessed portions 70 for accumulating ink having a diameter of 1.0 mm, a volume of 6.3 mm3, and being arranged in 32 rows and 5 columns in the disposing region 80. In this case, the total volume of the plurality of recessed portions 70 for accumulating ink is 1008 mm3.

After accumulating ink in the recessed portions 70 for accumulating ink of the four types of ink receiving portions 52 illustrated in FIGS. 5A to 5D, turning them upside down (making it so the opening portion 71 is orientated to open in the direction of gravity), and leaving them as they were, no liquid dripping was recognized from the recessed portions 70 for accumulating ink even after 48 hours had passed. Therefore, it was recognized that it is possible to hold ink in the recessed portions 70 for accumulating ink by atmospheric pressure without providing an ink absorbing material such as a sponge.

Furthermore, in the recessed portions 70 for accumulating ink of the four types of ink receiving portions 52 illustrated in FIGS. 5A to 5D, it was recognized that more ink was accumulated in the order in which the total volume was large. In other words, it was recognized that more ink was accumulated in this order: the recessed portions 70 for accumulating ink with a diameter of 2.0 mm, the recessed portions 70 for accumulating ink with a diameter of 1.5 mm, the recessed portions 70 for accumulating ink with a diameter of 2.5 mm, and the recessed portions 70 for accumulating ink with a diameter of 1.0 mm.

In the first embodiment of the present invention, one or more of the following effects may be obtained.

As described above, in the first embodiment of the present invention, the depth D1 of the recessed portions 70 for accumulating ink of the recessed portion group 90 for accumulating ink is made to be larger than the shortest width D2 of the opening portion 71 of each recessed portion 70 for accumulating ink in a planar view. By this, ink is held in each recessed portion 70 for accumulating ink of the recessed portion group 90 for accumulating ink by atmospheric pressure when the printer 100 is tilted. As a result, it is possible to suppress ink from overflowing to the outside even when an ink absorbing material is not provided. Furthermore, more ink can be accumulated in each recessed portion 70 for accumulating ink because the capacity of each recessed portion 70 for accumulating ink can be made larger. As a result, ink accumulated in each recessed portion 70 for accumulating ink exceeding an amount that can be stored and overflowing can be suppressed.

Furthermore, as described above, in the first embodiment of the present invention, the depth D1 of each recessed portion 70 for accumulating ink is two times larger than the shortest width D2 of the opening portion 71 of each recessed portion 70 for accumulating ink in a planar view. By this, even more ink can be accumulated in each recessed portion 70 for accumulating ink because the capacity of each recessed portion 70 for accumulating ink can be made even larger. As a result, ink accumulated in each recessed portion 70 for accumulating ink exceeding an amount that can be stored and overflowing can be further suppressed.

Furthermore, as described above, in the first embodiment of the present invention, each recessed portion 70 for accumulating ink has a shape tapering from the opening portion 71 to the bottom portion 72. By this, ink can be easily accumulated in each recessed portion 70 for accumulating ink because it is easier for ink that has entered from the opening portion 71 to slide and fall toward the bottom portion 72. Furthermore, when forming the recessed portion group 90 for accumulating ink by resin using resin molding, resistance when taking the recessed portion group 90 for accumulating ink out of the resin mold can be made smaller by each recessed portion 70 for accumulating ink having a shape tapering from the opening portion 71 to the bottom portion 72. By this, it can be easier to take the recessed portion group 90 for accumulating ink from the resin mold. Therefore, the disposing position of each recessed portion 70 for accumulating ink can be closer because the recessed portion group 90 for accumulating ink can be easily taken out from the resin mold even if each recessed portion 70 for accumulating ink is relatively close. As a result, ink discharged from the printing head 10 can be made easier to accumulate in each recessed portion 70 for accumulating ink because the surface area of portions where each recessed portion 70 for accumulating ink is not formed (for example, flat portions between each adjacent recessed portion 70 for accumulating ink) can be reduced.

Furthermore, as described above, in the first embodiment of the present invention, the opening portion 71 of each recessed portion 70 for accumulating ink has a substantially circular shape in a planar view. Each recessed portion 70 for accumulating ink is formed so that the diameter of the circle gradually gets smaller from the opening portion 71 to the bottom portion 72. By this, each recessed portion 70 for accumulating ink can be formed having a tapering shape by a simple configuration.

Moreover, as described above, in the first embodiment of the present invention, the diameter D2 of the opening portion 71 having a substantially circular shape is approximately 1.0 mm or more and approximately 2.5 mm or less. By this, by making the diameter D2 of the opening portion 71 having a substantially circular shape be 1.0 mm or more, each recessed portion 70 for accumulating ink can be easier to form compared to when the diameter D2 of the opening portion 71 having a substantially circular shape is smaller than approximately 1.0 mm. This effect is particularly effective when forming the ink receiving portion 52 by resin using a resin mold. Furthermore, by making the diameter D2 of the opening portion 71 having a substantially circular shape approximately 2.5 mm or less, ink can surely be held in each recessed portion 70 for accumulating ink by atmospheric pressure.

Furthermore, as described above, in the first embodiment of the present invention, each recessed portion 70 for accumulating ink is arranged along the X-direction and Y-direction in a planar view on the disposing region 80 on the ink receiving portion 52. By this, ink discharged from the printing head 10 can be made easier to accumulate in each recessed portion 70 for accumulating ink because the surface area of portions where each recessed portion 70 for accumulating ink is not formed can be reduced in the disposing region 80, different than when the plurality of recessed portions 70 for accumulating ink are disposed irregularly on the disposing region 80 on the ink receiving portion 52.

Furthermore, as described above, in the first embodiment of the present invention, each recessed portion 70 for accumulating ink is arranged along the movement direction (Y-direction) of the printing head 10 on the disposing region 80 on the ink receiving portion 52. By this, ink discharged from the printing head 10 can be made easier to accumulate in each recessed portion 70 for accumulating ink because each recessed portion 70 for accumulating ink is arranged along the movement direction of the printing head 10.

Furthermore, as described above, in the first embodiment of the present invention, the plurality of recessed portions 70 for accumulating ink are arranged along a direction (X-direction) orthogonal to the movement direction of the printing head 10 on the disposing region 80 on the ink receiving portion 52. By this, ink can be easily accumulated in each recessed portion 70 for accumulating ink even when ink is discharged from the printing head 10 expanding in a direction orthogonal to the movement direction of the printing head 10.

Furthermore, as described above, in the first embodiment of the present invention, the plurality of recessed portions 70 for accumulating ink are arranged having a plurality of rows and a plurality of columns on the disposing region 80 on the ink receiving portion 52. By this, the surface area of portions where each recessed portion 70 for accumulating ink is not formed can be reduced on the disposing region 80 on the ink receiving portion 52 even when each recessed portion 70 for accumulating ink is relatively small to hold ink by atmospheric pressure because the plurality of recessed portions 70 for accumulating ink are densely disposed on the disposing region 80 on the ink receiving portion 52.

As a result, ink discharged from the printing head 10 can be easily accumulated in the plurality of recessed portions 70 for accumulating ink.

Furthermore, as described above, in the first embodiment of the present invention, the distance D3 between adjacent recessed portions 70 for accumulating ink is smaller than the shortest width D2 of the opening portion 71 in a planar view. By this, the surface area of portions where each recessed portion 70 for accumulating ink is not formed can be reduced on the disposing region 80 on the ink receiving portion 52 because the disposing position of each recessed portion 70 for accumulating ink can be closer. As a result, ink discharged from the printing head 10 can easily be accumulated in each recessed portion 70 for accumulating ink.

Furthermore, as described above, in the first embodiment of the present invention, the plurality of recessed portions 70 for accumulating ink are provided along substantially the entire region of the disposing region 80 on the ink receiving portion 52. By this, ink discharged from the printing head 10 can be surely accumulated in each recessed portion 70 for accumulating ink.

Furthermore, as described above, in the first embodiment of the present invention, the bottom portion 72 of each recessed portion 70 for accumulating ink is formed in a flat surface shape. By this, it can be easier to form each recessed portion 70 for accumulating ink because the bottom portion 72 of each recessed portion 70 for accumulating ink can be made into a simple shape. This effect is particularly effective when forming the recessed portion group 90 for accumulating ink by resin using a resin mold.

Furthermore, as described above, in the present embodiment, the recessed portion group 90 for accumulating ink is provided lower than the supporting surface of the recording medium 101 on the platen portion 50. By this, ink accumulated in each recessed portion 70 for accumulating ink adhering to the recording medium 101 can be suppressed.

Moreover, as described above, in the present embodiment, the ink receiving portion 52 is integrally formed having the platen portion 50. By this, the recessed portion group 90 for accumulating ink can be provided on the printer 100 while suppressing the number of components from increasing.

Moreover, as described above, in the present embodiment, the platen portion 50 and ink receiving portion 52 are integrally formed having the housing 100a. By this, the recessed portion group 90 for accumulating ink can be provided on the printer 100 while suppressing the number of components from increasing.

Furthermore, as described above, in the first embodiment of the present invention, the width W1 of the recessed portion group 90 for accumulating ink in the movement direction of the printing head 10 (Y-direction) is larger than the width W2 of the entirety of the supporting surfaces (upper surface of the ribs 51) of the platen portion 50 in the movement direction of the printing head 10. By this, discharged ink sticking out of the recording medium 101 in the movement direction of the printing head 10 can be surely accumulated in each recessed portion 70 for accumulating ink.

### Second Embodiment

Next, a second embodiment of the present invention will be described referring to FIG. 1 and FIG. 6 to FIG. 8. In this second embodiment, an example will be described that is different from the first embodiment of the present invention, where recessed portions for accumulating ink having an opening portion with a substantially rectangular shape are provided on the ink receiving portion. Note that configurations that are similar to the first embodiment of the present invention are illustrated with the same reference numerals in the drawings, and details thereof are omitted.

(Configuration of Printing Device)

A printer 200 according to the second embodiment of the present invention of the present invention differs from the printer 100 of the first embodiment of the present invention in that it includes a platen portion 150, as illustrated in FIG. 1.

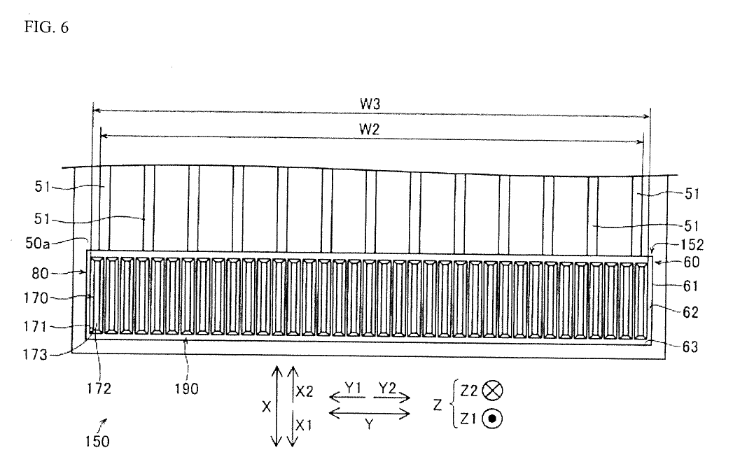

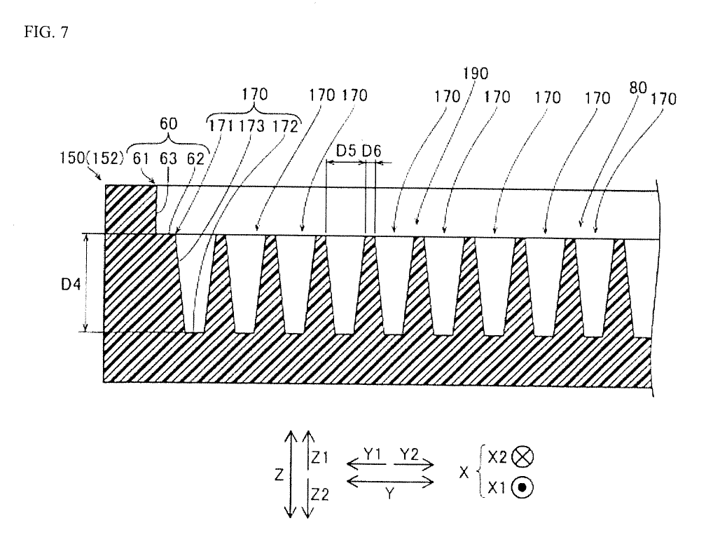

As illustrated in FIG. 1, FIG. 6, and FIG. 7, an ink receiving portion 152 is provided integrally with the platen portion 150.

As illustrated in FIG. 6 and FIG. 7, in the second embodiment of the present invention, a recessed portion group 190 for accumulating ink is provided on a bottom portion 62 of a recessed portion 60 on the ink receiving portion 152. The recessed portion group 190 for accumulating ink is configured by a plurality of recessed portions 170 for accumulating ink. The recessed portion group 190 for accumulating ink is one example of “recessed portion group” in one or more embodiments of the present invention. Furthermore, each recessed portion 170 for accumulating ink is one example of “each recessed portion” in one or more embodiments of the present invention. The recessed portions 170 for accumulating ink of the recessed portion group 190 for accumulating ink have a size where it is possible to hold ink by atmospheric pressure (and surface tension). As illustrated in FIG. 6 to FIG. 8, the recessed portions 170 for accumulating ink have an opening portion 171 and a bottom portion 172 having a substantially rectangular shape from a planar view, and a wall portion 173 that connects the opening portion 171 and the bottom portion 172. In the printer 200, discharged ink sticking out of the recording medium 101 from the printing head 10 enters the recessed portions 170 for accumulating ink from the opening portion 171, and accumulates in a space partitioned by the bottom portion 172 and the wall portion 173.

As illustrated in FIG. 7, in the second embodiment of the present invention, a depth (length from the opening portion 171 to the bottom portion 172) D4 of the recessed portions 170 for accumulating ink is larger than a length D5 of the short sides of the opening portion 171 having a substantially rectangular shape. Specifically, the depth D4 of the recessed portions 170 for accumulating ink is two times larger than D5 of the short sides of the opening portion 171 having a substantially rectangular shape. The length D5 of the short sides of the opening portion 171 having a substantially rectangular shape is one example of “shortest width (shortest distance) of an opening portion of a recessed portion for accumulating ink in a planar view” in one or more embodiments of the present invention.

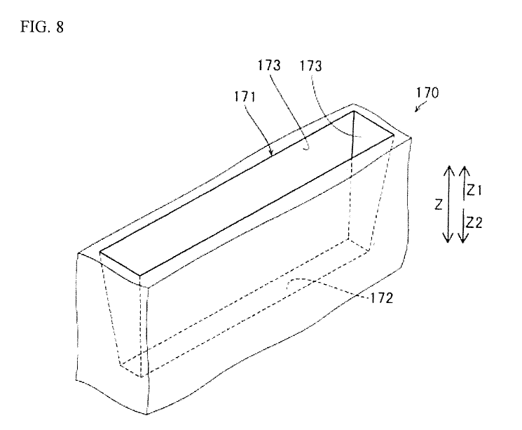

Moreover, as illustrated in FIG. 7 and FIG. 8, in the second embodiment of the present invention, the wall portion 173 of the recessed portions 170 for accumulating ink have a shape tapering from the opening portion 171 to the bottom portion 172. Specifically, the wall portion 173 of the recessed portions 170 for accumulating ink is formed so that the length of the four sides gradually decreases (gradually dwindles away) from the opening portion 171 having a substantially rectangular shape toward the bottom portion 172 having a substantially rectangular shape.

Furthermore, the bottom portion 172 of the recessed portions 170 for accumulating ink is formed in a flat surface shape along the horizontal direction. In other words, in the recessed portions 170 for accumulating ink, a substantially truncated pyramid-shaped space is formed by the opening portion 171, the bottom portion 172, and the wall portion 173. Ink accumulates in this substantially truncated pyramid-shaped space. Furthermore, a vertical cross-section (cross-section in the ZY plane) of the recessed portions 170 for accumulating ink has a trapezoidal shape.

Furthermore, as illustrated in FIG. 6, the opening portion 171 having a substantially rectangular shape is formed to extend along a direction orthogonal to the movement direction of the printing head 10 (X-direction) from the vicinity of the end portion of the X1 side on the disposing region 80 (side extending along the Y-direction on the X1 side) to the vicinity of the end portion opposite the end portion on the X1 side (side extending along the Y-direction on the X2 side).

Furthermore, in the second embodiment of the present invention, the plurality of recessed portions 170 for accumulating ink are arranged with substantially equal spacing therebetween along a direction orthogonal to the movement direction of the printing head 10 (X-direction) in a planar view on the disposing region 80 on the ink receiving portion 152. Furthermore, the recessed portion group 190 for accumulating ink (plurality of recessed portions 170 for accumulating ink) is provided along substantially the entire region of the disposing region 80. The X-direction is one example of “predetermined direction” in one or more embodiments of the present invention.

Moreover, as illustrated in FIG. 7, a distance D6 between adjacent recessed portions 170 for accumulating ink is smaller than the length D5 of the short sides of the opening portion 171 having a substantially rectangular shape. In other words, adjacent recessed portions 170 for accumulating ink are arranged to be sufficiently close to each other on the disposing region 80 (so that a flat portion does not occur between adjacent recessed portions 170 for accumulating ink as much as possible).

Furthermore, as illustrated in FIG. 6, in the second embodiment of the present invention, a width W3 of the entire recessed portion group 190 for accumulating ink in the movement direction of the printing head (Y-direction) is larger than a width W2 of the entire plurality of supporting surfaces (upper surface of the ribs 51) of the platen portion 50 in the movement direction of the printing head 10. In other words, the recessed portion group 190 for accumulating ink is formed more to the outer side than the plurality of supporting surfaces of the platen portion 50 in the movement direction of the printing head 10.

The other configurations of the second embodiment of the present invention are similar to the first embodiment of the present invention.

In the second embodiment of the present invention, one or more of the following effects may be obtained.

As described above, in the second embodiment of the present invention, the opening portion 171 of each recessed portion 170 for accumulating ink has a substantially rectangular shape in a planar view. Each recessed portion 170 for accumulating ink is formed so that the length of the four sides of the rectangular shape gradually gets smaller from the opening portion 171 to the bottom portion 172. By this, it is easier for ink that has entered from the opening portion 171 to slide and fall toward the bottom portion 172 because each recessed portion 170 for accumulating ink has a tapering shape where the length of all sides of the rectangular shape (four sides) gradually decrease.

Furthermore, as described above, in the second embodiment of the present invention, the opening portion 171 of each recessed portion 170 for accumulating ink is formed to extend from the vicinity of the end portion of one side on the disposing region 80 (the X1 side) to the vicinity of the end portion opposite the end portion on the one side (end portion on the X2 side). By this, the number of recessed portions 170 for accumulating ink disposed on the disposing region 80 can be reduced because the capacity of one recessed portion 170 for accumulating ink can be made larger. As a result, it can be easier to form each recessed portion 170 for accumulating ink.

Note that the second embodiment of the present invention may have effects similar to the first embodiment of the present invention.

### Third Embodiment

Next, a third embodiment of the present invention will be described referring to FIG. 1 and FIG. 9 to FIG. 11. In the third embodiment of the present invention, an example will be described that is different from the second embodiment of the present invention of the present invention, that is an example where recessed portions for accumulating ink having an opening portion with a substantially rectangular shape are provided on the ink receiving portion. Note that configurations that are similar to the first or second embodiment are illustrated with the same reference numerals in the drawings, and details thereof are omitted.

(Configuration of Printing Device)

A printer 300 according to the third embodiment of the present invention differs from the printer 100 of the first embodiment of the present invention in that it includes a platen portion 250, as illustrated in FIG. 1.

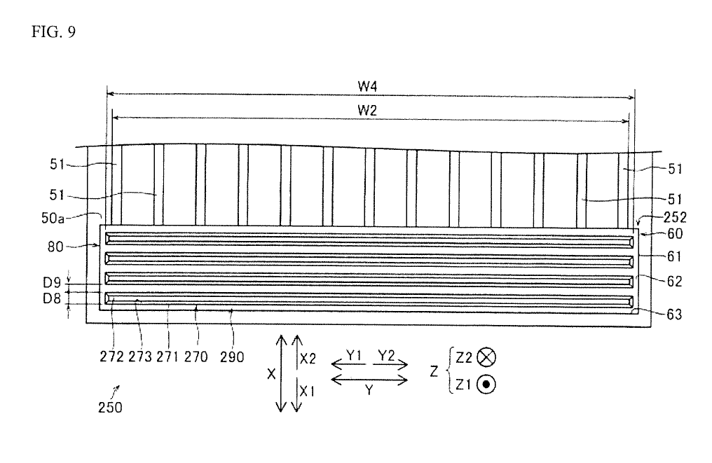

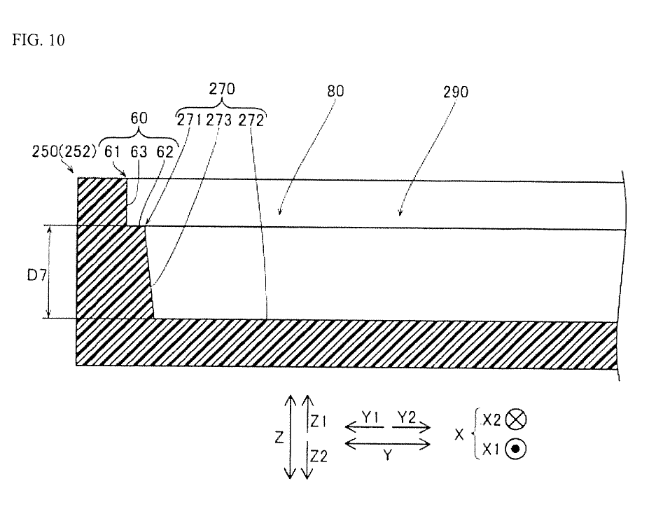

As illustrated in FIG. 1, FIG. 9, and FIG. 10, an ink receiving portion 252 is provided integrally with the platen portion 250.

As illustrated in FIG. 9 and FIG. 10, in the second embodiment of the present invention, a recessed portion group 290 for accumulating ink is provided on the bottom portion 62 of the recessed portion 60 on the ink receiving portion 252. The recessed portion group 290 for accumulating ink is configured by a plurality of recessed portions 270 for accumulating ink. The recessed portion group 290 for accumulating ink is one example of “recessed portion group” in one or more embodiments of the present invention. Furthermore, each recessed portion 270 for accumulating ink is one example of “each recessed portion” in one or more embodiments of the present invention. The recessed portions 270 for accumulating ink of the recessed portion group 290 for accumulating ink have a size where it is possible to hold ink by atmospheric pressure (and surface tension). As illustrated in FIG. 9 to FIG. 11, the recessed portions 270 for accumulating ink have an opening portion 271 and a bottom portion 272 having a substantially rectangular shape in a planar view, and a wall portion 273 that connects the opening portion 271 and the bottom portion 272. In the printer 300, discharged ink sticking out of the recording medium 101 from the printing head 10 enters the recessed portions 270 for accumulating ink from the opening portion 271, and accumulates in a space partitioned by the bottom portion 272 and the wall portion 273.

As illustrated in FIG. 9 and FIG. 10, in the third embodiment of the present invention, a depth (length from the opening portion 271 to the bottom portion 272) D7 of the recessed portions 270 for accumulating ink is larger than the length D8 of the sort sides of the opening portion 271 having a substantially circular shape. Specifically, the depth D7 of the recessed portions 270 for accumulating ink is two times larger than D8 of the short sides of the opening portion 271 having a substantially rectangular shape. The length D8 of the short sides of the opening portion 271 having a substantially rectangular shape is one example of “shortest width (shortest distance) of an opening portion of a recessed portion for accumulating ink in a planar view” in one or more embodiments of the present invention. The length D8 is a width of the opening portion 271 in a view from a moving direction of the printing head (Y-direction).

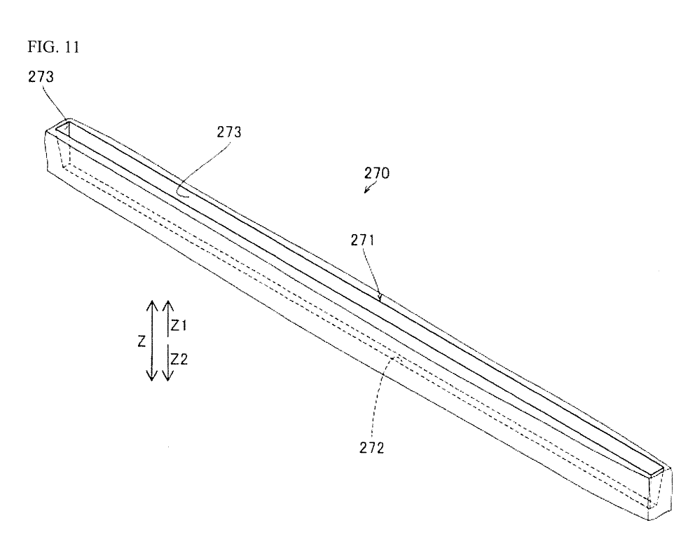

Furthermore, as illustrated in FIG. 10 and FIG. 11, in the third embodiment of the present invention, the wall portion 273 of the recessed portions 270 for accumulating ink has a shape tapering from the opening portion 271 to the bottom portion 272. Specifically, the wall portion 273 of the recessed portions 270 for accumulating ink is formed so that the length of the four sides gradually decreases (gradually dwindles away) from the opening portion 271 having a substantially rectangular shape toward the bottom portion 272 having a substantially rectangular shape.

Furthermore, the bottom portion 272 of the recessed portions 270 for accumulating ink is formed in a flat surface shape along the horizontal direction. In other words, in the recessed portions 270 for accumulating ink, a substantially truncated pyramid-shaped space is formed by the opening portion 271, the bottom portion 272, and the wall portion 273. Ink accumulates in this substantially truncated pyramid-shaped space. Furthermore, a vertical cross-section (cross-section in the ZY plane) of the recessed portions 270 for accumulating ink has a trapezoidal shape.

Furthermore, as illustrated in FIG. 9, in the disposing region 80, the opening portion 271 having a substantially rectangular shape is formed to extend along the movement direction of the printing head 10 (Y direction) from the vicinity of the end portion of the Y1 side on the disposing region 80 (side extending along the X-direction on the Y1 side) to the vicinity of the end portion on the Y2 side opposite the end portion on the Y1 side (side extending along the X-direction on the Y2 side). In other words, in the third embodiment of the present invention, the recessed portions 270 for accumulating ink are formed on the disposing region 80, being larger than the recessed portions 170 for accumulating ink in the second embodiment of the present invention.

Furthermore, in the third embodiment of the present invention, the plurality of recessed portions 270 for accumulating ink are arranged with substantially equal spacing therebetween along the movement direction of the printing head 10 (Y-direction) in a planar view on the disposing region 80 on the ink receiving portion 252. Furthermore, the recessed portion group 290 for accumulating ink (plurality of recessed portions 270 for accumulating ink) is provided along substantially the entire region of the disposing region 80. The Y-direction is one example of “predetermined direction” in one or more embodiments of the present invention.

Moreover, as illustrated in FIG. 10, a distance D9 between adjacent recessed portions 270 for accumulating ink is smaller than the length D8 of the short sides of the opening portion 271 having a substantially rectangular shape. In other words, adjacent recessed portions 270 for accumulating ink are arranged to be sufficiently close to each other on the disposing region 80 (so that a flat portion does not occur between adjacent recessed portions 270 for accumulating ink as much as possible).

Furthermore, as illustrated in FIG. 9, in the third embodiment of the present invention, a width W4 (width in the Y-direction of the recessed portions 290 for accumulating ink) of the entire recessed portion group 290 for accumulating ink in the movement direction of the printing head 10 (Y-direction) is larger than a width W2 of the entire plurality of supporting surfaces (upper surface of the ribs 51) of the platen portion 50 in the movement direction of the printing head 10. In other words, the recessed portion group 290 for accumulating ink is formed more to the outer side than the plurality of supporting surfaces of the platen portion 50 in the movement direction of the printing head 10.

The other configurations of the third embodiment of the present invention are similar to the first embodiment of the present invention.

In the third embodiment of the present invention, one or more of the following effects may be obtained.

As described above, in the third embodiment of the present invention, the opening portion 271 of each recessed portion 270 for accumulating ink is formed to extend from the vicinity of the end portion of one side in the longitudinal direction on the disposing region 80 (the Y1 side) to the vicinity of the end portion opposite the end portion on the one side in the longitudinal direction (end portion on the Y2 side). By this, the number of recessed portions 270 for accumulating ink disposed on the disposing region 80 can be reduced because the capacity of one recessed portion 270 for accumulating ink can be made larger. As a result, it can be easier to form each recessed portion 270 for accumulating ink.

The third embodiment of the present invention may have effects similar to the first embodiment of the present invention.

### Modified Examples

It should be considered that the currently disclosed embodiments are merely examples, and do not limit the present invention. The scope of the present invention is shown not by the description above, but one or more embodiments of the present invention, and all changes (modifications) within the scope of the patent claims and equal scopes and meanings are included.

For example, in the first to third embodiments of the present invention, an example was shown where the recessed portions for accumulating ink have a shape tapering from the opening portion to the bottom portion, but the present invention is not limited to this. In the present invention, the recessed portions for accumulating ink may have a shape other than a shape tapering from the opening portion to the bottom portion.

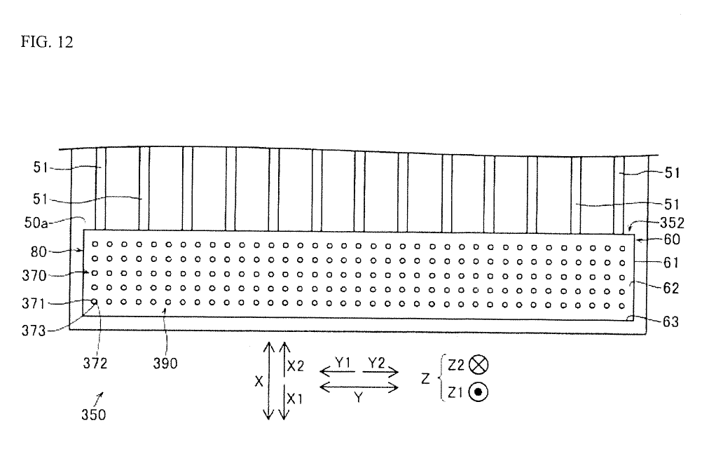

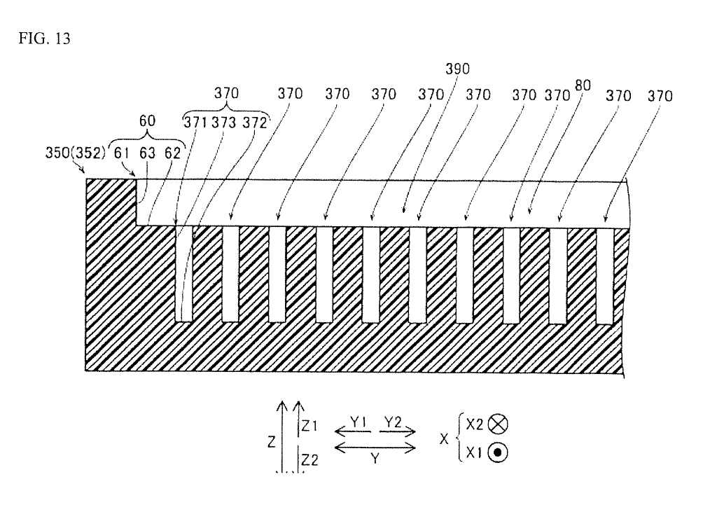

For example, as illustrated in FIG. 12 and FIG. 13, an ink receiving portion 352 is integrally provided with a platen portion 350 in the first modified example of the first embodiment of the present invention. A recessed portion group 390 for accumulating ink configured by a plurality of recessed portions 370 for accumulating ink is provided on the ink receiving portion 352. The recessed portion group 390 for accumulating ink is one example of “recessed portion group” in one or more embodiments of the present invention. Furthermore, each recessed portion 370 for accumulating ink is one example of “each recessed portion” in one or more embodiments of the present invention. The recessed portions 370 for accumulating ink have an opening portion 371 and a bottom portion 372 having a substantially rectangular shape in a planar view, and a wall portion 373 that connects the opening portion 371 and the bottom portion 372. In the first modified example of the first embodiment of the present invention, the wall portion 373 of the recessed portions 370 for accumulating ink has a shape extending from the opening portion 371 to the bottom portion 372 along the vertical direction (Z-direction). Furthermore, the bottom portion 372 of the recessed portions 370 for accumulating ink is formed in a flat surface shape along the horizontal direction. In other words, in the recessed portions 370 for accumulating ink in the first modified example of the first embodiment of the present invention, a substantially column-shaped space is formed by the opening portion 371, the bottom portion 372, and the wall portion 373. Furthermore, the recessed portions 370 for accumulating ink with the substantially column-shaped space formed thereon are provided along substantially the entire region of the disposing region 80.

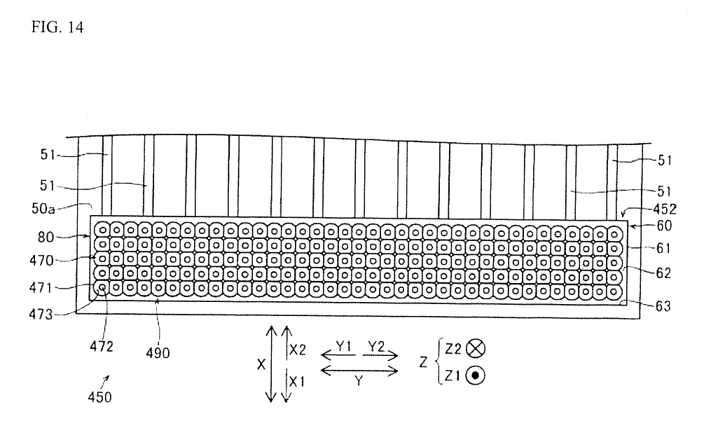

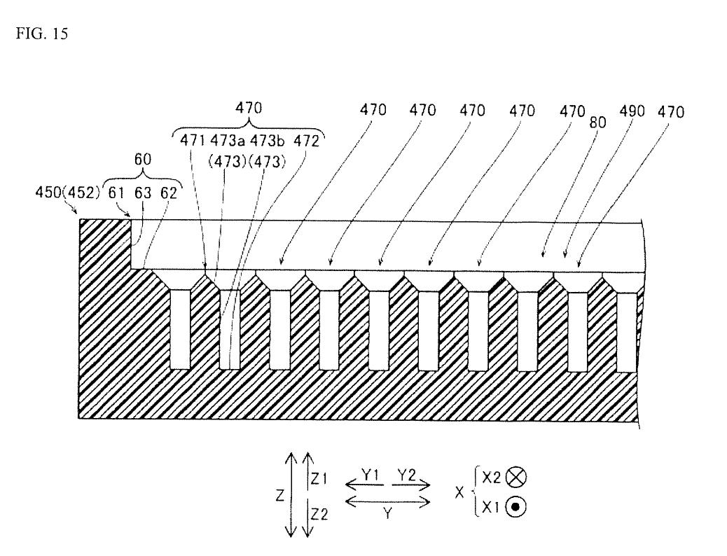

Furthermore, as illustrated in FIG. 14 and FIG. 15, an ink receiving portion 452 is integrally provided with a platen portion 450 in the second modified example of the first embodiment of the present invention. A recessed portion group 490 for accumulating ink configured by a plurality of recessed portions 470 for accumulating ink is provided on the ink receiving portion 452. The recessed portion group 490 for accumulating ink is one example of “recessed portion group” in one or more embodiments of the present invention. Furthermore, each recessed portion 470 for accumulating ink is one example of “each recessed portion” in one or more embodiments of the present invention. The recessed portions 470 for accumulating ink have an opening portion 471 and a bottom portion 472 having a substantially circular shape in a planar view, and a wall portion 473 that connects the opening portion 471 and the bottom portion 472. In the second modified example of the first embodiment of the present invention, the wall portion 473 of the recessed portions 470 for accumulating ink has a first wall portion part 473a having a shape tapering from the opening portion 471 toward a second wall portion part 473b, and a second wall portion part 473b having a shape extending along the vertical direction (Z-direction) from the lower end of the first wall portion part 473a to the bottom portion 472. The first wall portion part 473a of the wall portion 473 is formed by beveling the corner portions of the opening portion 371 shown in the first modified example of the first embodiment of the present invention (see FIG. 12 and FIG. 13). In other words, the recessed portions 470 for accumulating ink in the second modified example of the first embodiment of the present invention bevels is made by beveling the opening portion 371 of the recessed portions 370 for accumulating ink in the first modified example of the first embodiment of the present invention. By this, because the opening portion 471 in the second modified example of the first embodiment of the present invention is made larger, it can be easier for ink to enter into the recessed portions 470 for accumulating ink, and because the surface area of portions where the recessed portions 470 for accumulating ink are not formed can be reduced on the ink receiving portion 470, ink discharged from the printing head can be surely accumulated in the recessed portions 470 for accumulating ink. The opening portion 471 is one example of “beveled opening portion” in one or more embodiments of the present invention.

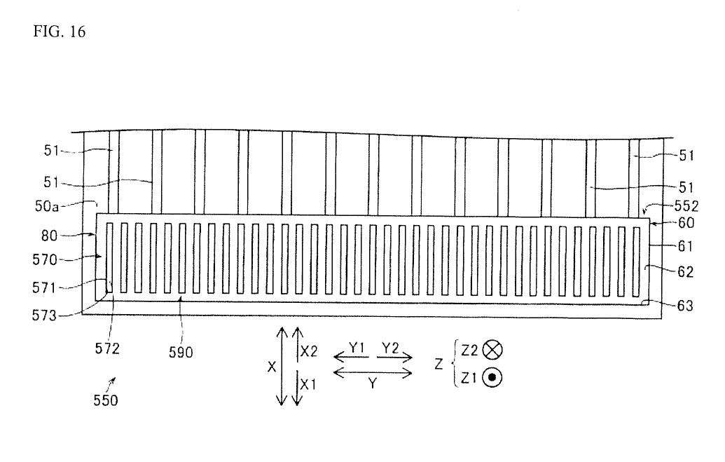

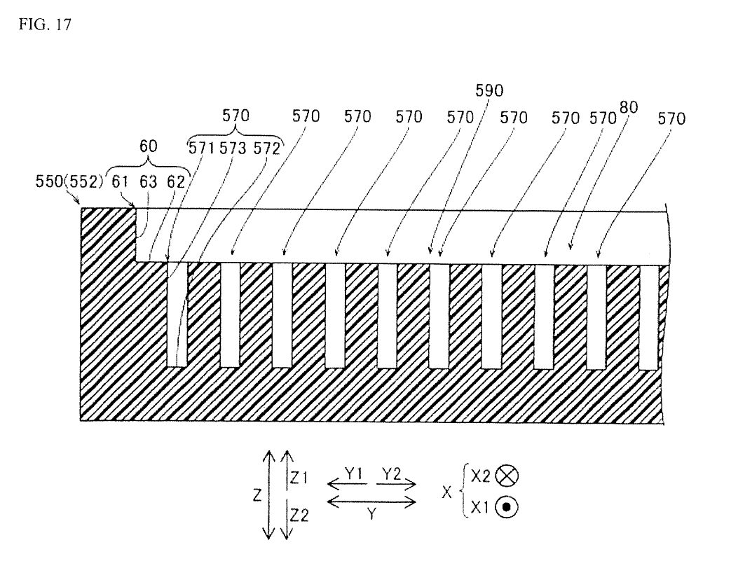

As illustrated in FIG. 16 and FIG. 17, in the first modified example of the second embodiment of the present invention, an ink receiving portion 552 is integrally provided on a platen portion 550. The ink receiving portion 552 includes a recessed portion group 590 for accumulating ink configured by a plurality of recessed portions 570 for accumulating ink. The recessed portion group 590 for accumulating ink is one example of “recessed portion group” in one or more embodiments of the present invention. Furthermore, each recessed portion 570 for accumulating ink is one example of “each recessed portion” in one or more embodiments of the present invention. The recessed portions 570 for accumulating ink have an opening portion 571 and a bottom portion 572 having a substantially rectangular shape in a planar view, and a wall portion 573 that connects the opening portion 571 and the bottom portion 572. In the first modified example of the second embodiment of the present invention, the wall portion 573 of the recessed portions 570 for accumulating ink has a shape extending from the opening portion 571 to the bottom portion 572 along the vertical direction (Z-direction). Furthermore, the bottom portion 572 of the recessed portions 570 for accumulating ink is formed in a flat surface shape along the horizontal direction. In other words, in the recessed portions 570 for accumulating ink in the first modified example of the second embodiment of the present invention, a substantially square-shaped space is formed by the opening portion 571, the bottom portion 572, and the wall portion 573. Furthermore, the recessed portions 570 for accumulating ink having a substantially square-shaped space are provided along substantially the entire region of the disposing region 80.

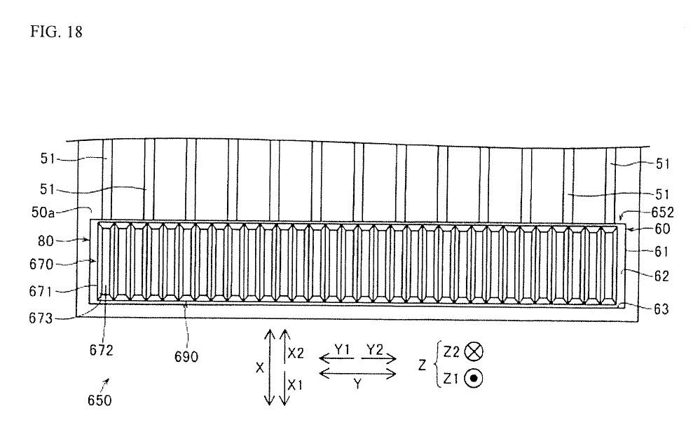

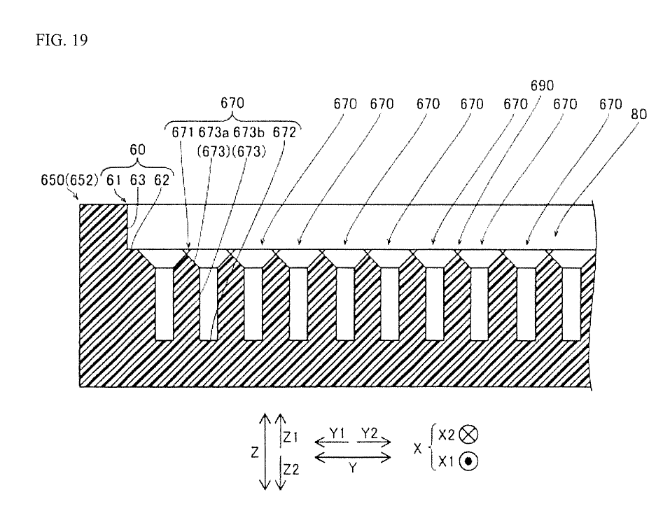

Moreover, as illustrated in FIG. 18 and FIG. 19, in the second modified example of the second embodiment of the present invention, an ink receiving portion 652 is integrally provided on a platen portion 650. The ink receiving portion 652 includes a recessed portion group 690 for accumulating ink configured by a plurality of recessed portions 670 for accumulating ink. The recessed portion group 690 for accumulating ink is one example of “recessed portion group” in one or more embodiments of the present invention. Furthermore, each recessed portion 670 for accumulating ink is one example of “each recessed portion” in one or more embodiments of the present invention. The recessed portions 670 for accumulating ink have an opening portion 671 and a bottom portion 672 having a substantially rectangular shape in a planar view, and a wall portion 673 that connects the opening portion 671 and the bottom portion 672. In the second modified example of the second embodiment of the present invention, the wall portion 673 of the recessed portions 670 for accumulating ink has a first wall portion part 673a having a shape tapering from the opening portion 671 toward a second wall portion part 673b, and a second wall portion part 673b having a shape extending along the vertical direction (Z-direction) from the lower end of the first wall portion part 673a to the bottom portion 672. The first wall portion part 673a of the wall portion 673 is formed by beveling the corner portions of the opening portion 571 shown in the first modified example of the second embodiment of the present invention (see FIG. 16 and FIG. 17). In other words, the recessed portions 670 for accumulating ink in the second modified example of the second embodiment of the present invention are made by beveling the opening portion 571 of the recessed portions 570 for accumulating ink in the first modified example of the second embodiment. By this, because the opening portion 671 in the second modified example of the second embodiment of the present invention is made larger, it can be easier for ink to enter into the recessed portions 670 for accumulating ink, and because the surface area of portions where the recessed portions 670 for accumulating ink are not formed can be reduced on the ink receiving portion 670, ink discharged from the printing head can be surely accumulated in the recessed portions 670 for accumulating ink. The opening portion 671 is one example of “beveled opening portion” in one or more embodiments of the present invention.

Furthermore, an example was shown in the first to third embodiments where the depth of the recessed portions for accumulating ink is larger than the shortest width (diameter of the opening portion or length of short sides of the opening portion) of the opening portion of the recessed portions for accumulating ink in a planar view, but one or more embodiments of the present invention is not limited to this. In one or more embodiments of the present invention, if ink can be sufficiently accumulated, the depth of the recessed portions for accumulating ink may be lower that the shortest width of the opening portion of the recessed portions for accumulating ink in a planar view.

Furthermore, in the first embodiment of the present invention, an example was shown where the opening portion of the recessed portions for accumulating ink have a substantially circular shape, and in the second and third embodiments, examples where shown where the opening portion of the recessed portions for accumulating ink have a substantially rectangular shape, but one or more embodiments of the present invention is not limited to these. In one or more embodiments of the present invention, the opening portion of the recessed portions for accumulating ink may have a shape other than a substantially circular shape or a substantially rectangular shape. For example, the opening portion of the recessed portions for accumulating ink may have a polygonal shape other than a rectangle, or may have an elliptical shape.

Furthermore, in the first to third embodiments, an example was shown where the recessed portions for accumulating ink were arranged along a predetermined direction (X-direction or Y-direction) in a planar view on the disposing region on the ink receiving portion, but one or more embodiments of the present invention is not limited to this. In one or more embodiments of the present invention, the recessed portions for accumulating ink do not need to be arranged along a predetermined direction in a planar view on the disposing region on the ink receiving portion. For example, the recessed portions for accumulating ink may be disposed irregularly on the disposing portion on the ink receiving portion.

Furthermore, in the first to third embodiments, an example was shown where a plurality of the same type (same shape) of recessed portions for accumulating ink were disposed on the ink receiving portion, but one or more embodiments of the present invention is not limited to this. In one or more embodiments of the present invention, the ink receiving portion includes a plurality of different types (different shapes) of recessed portions. In other words, a plurality of recessed portions includes a first recessed portion having a first shortest width (distance) of the opening portion, and a second recessed portion having a second shortest width (distance) of the opening portion that has a different value than the first shortest width.

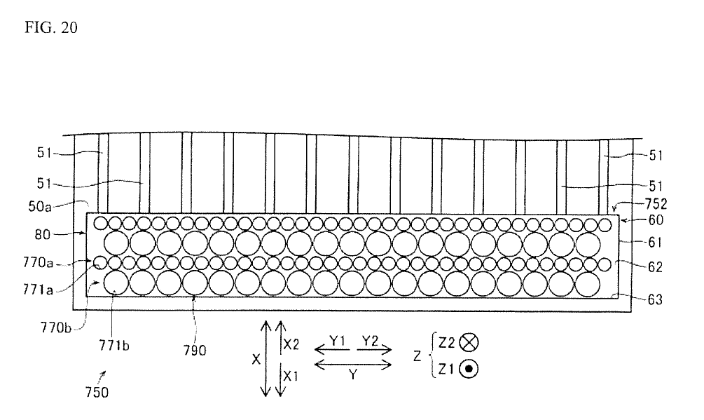

For example, as illustrated in FIG. 20, in the third modified example of the first embodiment of the present invention, an ink receiving portion 752 is integrally provided with a platen portion 750. The ink receiving portion 752 includes a recessed portion group 790 for accumulating ink. The recessed portion group 790 for accumulating ink is configured by two types of recessed portions 770a and 770b for accumulating ink, having different shortest widths of the opening portion. The recessed portion group 790 for accumulating ink is one example of “recessed portion group” in one or more embodiments of the present invention. Furthermore, each recessed portions 770a and 770b for accumulating ink is one example of “each recessed portion” in one or more embodiments of the present invention. The contact portions 770a for accumulating ink have an opening portion 771a having a substantially circular shape in a planar view. Moreover, the recessed portions 770b for accumulating ink have an opening portion 771b with a larger shortest width than the shortest width of the opening portion 771a. By this, each recessed portion 770a and 770b can easily be densely disposed. As a result, because the surface area of portions where each recessed portion 770a and 770b is not formed can be reduced, ink discharged from the printing head can be surely accumulated in each recessed portion 770a and 770b. Note that in the third modified example of the first embodiment of the present invention of the present invention, an example was shown where two different types of recessed portions 770a and 770b for accumulating ink are provided on the ink receiving portion 752, but in one or more embodiments of the present invention, three or more different types of recessed portions for accumulating ink may be provided on the ink receiving portion.

Furthermore, in the first to third embodiments of the present invention, an example was shown where the bottom portion of the recessed portions for accumulating ink is formed in a flat surface shape, but one or more embodiments of the present invention is not limited to this. In one or more embodiments of the present invention, the bottom portion of the recessed portions for accumulating ink may be a shape other than a flat surface shape. For example, the bottom portion may be formed in a shape that tapers downward when the recessed portions for accumulating ink have a shape tapering from the opening portion to the bottom portion as in the first to third embodiments.

Furthermore, in the first to third embodiments of the present invention, an example was shown where the platen portion and ink receiving portion are integrally formed having the housing, but one or more embodiments of the present invention is not limited to this. In one or more embodiments of the present invention, the platen portion and ink receiving portion do not need to be formed integrally with the housing. For example, the platen portion and ink receiving portion may be integrally formed separate from the housing. Furthermore, the ink receiving portion (ink receiving member) may be individually formed separate from the housing and the platen portion.

Furthermore, in the first to third embodiments of the present invention, an example was shown where the recessed portions for accumulating ink are provided across substantially the entire region of the disposing region, but one or more embodiments of the present invention is not limited to this. In one or more embodiments of the present invention, the recessed portions for accumulating ink do not need to be provided across substantially the entire region of the disposing region. In other words, there may be a region on the disposing region where recessed portions for accumulating ink are not provided.

Furthermore, in the first embodiment of the present invention, an example was shown where the diameter of the opening portion of recessed portions for accumulating ink was 1.0 mm or greater and 2.5 mm or less, but one or more embodiments of the present invention is not limited to this. In one or more embodiments of the present invention, if it is possible to form the recessed portions for accumulating ink, the diameter of the opening portion of the recessed portions for accumulating ink having a substantially circular shape may be smaller than 1.0 mm. Furthermore, if it is possible to hold ink in the recessed portions for accumulating ink by atmospheric pressure, the diameter of the opening portion of the recessed portions for accumulating ink having a substantially circular shape may be larger than 2.5 mm.

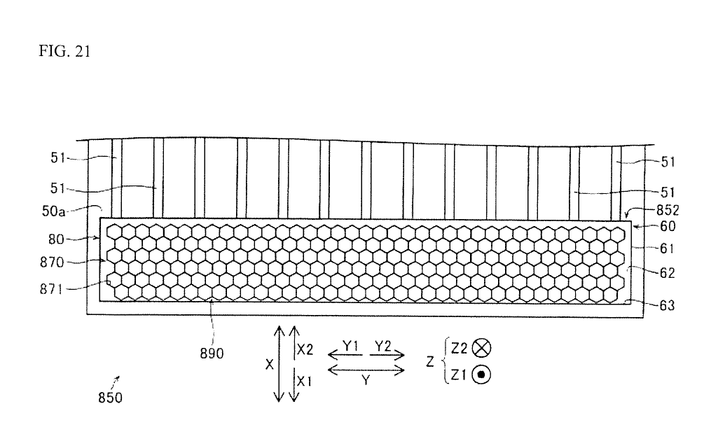

Furthermore, in the first embodiment of the present invention, an example was shown where the plurality of recessed portions for accumulating ink are arranged in a matrix to have a plurality of rows and a plurality of columns, but one or more embodiments of the present invention is not limited to this. In one or more embodiments of the present invention, for example, a plurality of recessed portions 870 for accumulating ink may be arranged in a honeycomb shape as in the platen portion 850 illustrated in FIG. 21. An ink receiving portion 852 is integrally provided on the platen portion 850. The ink receiving portion 852 includes a recessed portion group 890 for accumulating ink configured by a plurality of recessed portions 870 for accumulating ink. The recessed portion group 890 for accumulating ink is one example of “recessed portion group” in one or more embodiments of the present invention. Furthermore, each recessed portion 870 for accumulating ink is one example of “each recessed portion” in one or more embodiments of the present invention. The recessed portions 870 for accumulating ink have an opening portion 871 having a substantially regular hexagonal shape in a planar view. The recessed portions 870 for accumulating ink are arranged along the X-direction and Y-direction to be in a honeycomb shape.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
10 Printing head
50, 150, 250, 350, 450, 550, 650, 750, 850 Platen portion
52, 152, 252, 352, 452, 552, 652, 752, 852 Ink receiving portion
70, 170, 270, 370, 470, 570, 670, 770a, 770b, 870 Recessed portions for accumulating ink (recessed portions)
71, 171, 271, 371, 471, 571, 671, 771a, 771b, 871 Opening portion
72, 172, 272, 372, 472, 572, 672 Bottom portion
90, 190, 290, 390, 490, 590, 690, 790, 890 Recessed portion group for accumulating ink (recessed portion group)
100, 200, 300 Printer
100a Housing
101 Recording medium (medium)

What is claimed is:

1. A printer comprising:
a printing head; and
a plurality of recessed portions disposed to oppose the printing head,
wherein a depth of each of the recessed portions is larger than a shortest distance of an opening portion of each recessed portion in a planar view.

2. The printer according to claim 1, wherein the shortest distance is a width of the opening portion in a view from a medium feeding direction.

3. The printer according to claim 1, wherein the shortest distance is a width of the opening portion in a view from a moving direction of the printing head.

4. The printer according to claim 1, wherein the depth is more than two times larger than the shortest distance.

5. The printer according to claim 1, wherein each of the recessed portions has a shape tapering from the opening portion to a bottom portion of each of the recessed portion.

6. The printer according to claim 5,
wherein the opening portion has a circular shape in a planar view, and
wherein the shortest distance is a diameter of the circular shape.

7. The printer according to claim 6, wherein the diameter is greater than or equal to 1.0 mm and less than or equal to 2.5 mm.

8. The printer according to claim 5,
wherein the opening portion has a rectangular shape in a planar view, and
wherein the shortest distance is a short side of the rectangular shape.

9. The printer according to claim 1, wherein the plurality of recessed portions are arranged along a predetermined direction in a planar view.

10. The printer according to claim 9, wherein the predetermined direction includes a moving direction of the printing head.

11. The printer according to claim 9, wherein the predetermined direction includes a medium feeding direction.

12. The printer according to claim 9,
wherein the plurality of recessed portions are disposed on a region having a rectangular shape in a planar view, and
wherein the opening portion extends from a vicinity of an end portion of one side on the region to a vicinity of an end portion opposite the end portion on the one side.

13. The printer according to claim 1, wherein a distance between adjacent recessed portions in a planar view is less than the shortest distance.

14. The printer according to claim 1, wherein the bottom portion of the recessed portions is formed in a flat surface shape.

15. The printer according to claim 1, further comprising:
a platen portion that supports a medium,
wherein the plurality of recessed portions is disposed lower than a supporting surface of the medium on the platen portion.

16. The printer according to claim 15, wherein the platen portion comprises the plurality of recessed portions.

17. The printer according to claim 16, further comprising:
a housing,
wherein the housing comprises the platen portion.

18. The printer according to claim 1, wherein the opening portion is beveled.

19. The printer according to claim 1, wherein the plurality of recessed portions comprises:
a first recessed portion having a first shortest distance of the opening portion, and
a second recessed portion having a second shortest distance of the opening portion that has a different value than the first shortest distance.

20. The printer according to claim 15, wherein a width of the platen portion in a moving direction of the printing head is larger than a width of the supporting surfaces in the moving direction.
